(19) United States
(12) Patent Application Publication
(10) Pub. No.: US 2006/0085650 A1
(43) Pub. Date: Apr. 20, 2006

(54) Organism information authenticating apparatus, organism information registering apparatus, and organism information collating apparatus

(75) Inventor: Toshio Nakamura, Saitama (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/239,385

(22) Filed: Sep. 30, 2005

(30) Foreign Application Priority Data
Oct. 14, 2004 (JP) 2004-299603

(51) Int. Cl. H04K 1/00; G05B 19/00; G06K 9/00

(52) U.S. Cl. 713/186; 340/5.83; 382/124

(57) ABSTRACT

An organism information authenticating apparatus has an organism information forming unit which forms organism information and a target processing unit which executes a target process regarding authentication by using the organism information. When the target processing unit instructs activation, the organism information forming unit notifies the target processing unit of information for the target process. Processing information necessary for the target process is obtained. A processing procedure for the target process is decided. Quality of the organism information is discriminated. Re-forming of the organism information is instructed until the organism information which satisfies predetermined quality is formed. The target process is executed by using such organism information. The processing information is held and when the re-forming is instructed, new organism information is re-formed on the basis of the organism. The target processing unit is notified of the re-formed organism information.

### BACKGROUND OF THE INVENTION

1. Field of the Invention

The invention relates to an authenticating apparatus for performing personal authentication on the basis of organism information, an organism information registering apparatus, and an organism information collating apparatus.

2. Related Background Art

An authenticating apparatus for performing personal authentication by using information (biometrics) formed on the basis of organisms such as fingerprint, voiceprint, iris, vein, face type, or the like of the user has: a target processing unit which executes target processes such as registration of organism information, collation based on the organism information, the personal authentication based on a collation result, and the like and makes display control of a display screen in accordance with a processing situation in the target processes; and an organism information forming unit which, when an instruction from the target processing unit is received, forms the organism information on the basis of the organism of the user, notifies the target processing unit of the organism information, and makes the display control of the display screen according to a situation of the processes.

A special technique to obtain the organism information of predetermined quality and a dedicated technique for the display control of the display screen in the above processes have been installed in the organism information forming unit. The organism information forming units have been developed in various companies having such a special technique.

In the display screen whose display is controlled by the organism information forming unit, for example, the specifications such as screen construction, color arrangement, font, and the like have uniquely been determined in each company. Since the specifications are uniquely determined, therefore, the display screen whose display is controlled by the organism information forming unit and the display screen whose display is controlled by the target processing unit are not harmonized and associated in terms of the screen construction, color arrangement, font, and the like.

Moreover, the display screen whose display is controlled by the organism information forming unit and the display screen whose display is controlled by the target processing unit are independently displayed. That is, the display screen whose display is controlled by the target processing unit and the display screen whose display is controlled by the organism information forming unit are displayed in parallel in one display screen. Since the display screen whose display is controlled by the target processing unit and the display screen whose display is controlled by the organism information forming unit are displayed in parallel in one display screen as mentioned above and, further, the screen construction, color arrangement, font, and the like are not unified, there is such a problem that it is hard to see the display screen.

To solve such a problem, it is considered to use a technique called a “callback” in which in order to provide information necessary for the display control to the target processing unit, the organism information forming unit which received an activating instruction from the target processing unit obtains a predetermined address in the target processing unit from the target processing unit whose processing contents have been made to correspond to the address and hands over the control to the target processing unit shown by the obtained address, and the specifications for such a technique have been determined.

However, in the conventional organism information authenticating apparatus based on the determined specifications, information to select one of character trains which have been predetermined between the target processing unit and the organism information forming unit is notified from the organism information forming unit to the target processing unit and the character trains which are displayed on the display screen are merely switched on the basis of the information notified to the target processing unit. Therefore, control other than the switching control of the character trains is not made and there is such a problem that its generality is low.

Also in the conventional organism information authenticating apparatus, since the organism information is formed on the basis of the quality specifications which have uniquely been determined in the developing company of the organism information forming unit, in the quality specifications in which a countermeasure against the case where, for example, the optimum image cannot be obtained due to some cause is not sufficiently considered, in spite of the fact that the hardware-like functional specifications such as the number of photographing pixels and the like are sufficient, there is a fear that the organism information of high quality cannot be formed.

Specifically speaking, if the quality specifications have been predetermined so as to form the organism information on the basis of the image obtained by photographing the organism only once, for example, in a contact pressure, focusing, white balance, and the like in contact photographing, if a good organism image cannot be obtained due to some cause such as increase/decrease in contact pressure, backlight, or the like, the quality of the organism information which is formed on the basis of the image also deteriorates.

According to the quality specifications of the organism information obtaining unit, quality checks about the focusing, white balance, whether or not an object was caught, and the like are performed to the image obtained by photographing the organism and the organism is photographed again as necessary. However, if a discrimination reference in the quality checks is lax, in spite of the image whose quality is substantially low, there is a fear that such an image is determined to be not the image of the low quality. There is a fear that the organism information of the low quality is formed on the basis of the image of substantially the low quality.

As mentioned above, in the conventional organism information authenticating apparatus, the organism information is formed on the basis of the quality specifications which have uniquely been determined in the developing company of the organism information forming unit and the quality of the organism information is not objectively discriminated. Therefore, there is a fear that the target process is executed by using the organism information of substantially the low quality and it causes a problem.

### SUMMARY OF THE INVENTION

In consideration of the above problems, it is an object of the invention to provide an organism information authenticating apparatus which improves the generality and obtains organism information of high quality.

Another object of the invention is to provide an organism information registering apparatus which improves the generality, obtains organism information of high quality, and registers it.

Further another object of the invention is to provide an organism information collating apparatus which improves the generality, obtains organism information of high quality, and collates it.

According to the present invention, there is provided an organism information authenticating apparatus comprising:

an organism information forming unit which forms organism information on the basis of an organism; and

a target processing unit which executes a target process regarding authentication by using the organism information formed by the organism information forming unit,

in which when the target processing unit instructs activation of the organism information forming unit, the organism information forming unit notifies the target processing unit of information for the target process,

wherein the target processing unit has

a processing information obtaining unit which obtains processing information necessary for the target process by the notification from the organism information forming unit;

a processing procedure deciding unit which decides a processing procedure for the target process on the basis of the obtained processing information;

a quality managing unit which discriminates quality of the organism information formed by the organism information forming unit and instructs the organism information forming unit to form the organism information again until organism information which satisfies predetermined quality is formed in accordance with the decided processing procedure; and

a processing unit which executes the target process by using the organism information which satisfies the predetermined quality in accordance with the processing procedure, and

the organism information forming unit has

a processing information holding unit which holds the processing information, and

an organism information re-forming unit which forms new organism information again on the basis of the organism when it receives the re-forming instruction from the processing unit and notifies the target processing unit of the re-formed organism information.

Moreover, in the organism information authenticating apparatus, at least one of the following information is shown in the information:

organism type information showing a type of the organism;

kind information showing a kind of information included in the organism information;

progress information showing a progress of the processing procedure;

status information showing an operating mode of the organism information forming unit;

application information showing a using method of the organism information in the target process; and

registration number information showing the number of registered items in the organism information of the organism.

Moreover, in the organism information authenticating apparatus, the processing procedure deciding unit decides the next processing procedure on the basis of at least one of the progress information showing the progress of the processing procedure and the status information showing the operating mode of the organism information forming unit.

Moreover, in the organism information authenticating apparatus, the target processing unit has a display screen control unit which makes display control of a display screen, and the display screen control unit makes the display control of the display screen in accordance with the processing procedure.

Moreover, in the organism information authenticating apparatus, the display screen control unit makes the display control of the display screen on the basis of at least one of the progress information showing the progress of the processing procedure and the status information showing the operating mode of the organism information forming unit.

Moreover, in the organism information authenticating apparatus, the quality managing unit makes a severe quality management by collating a plurality of organism information which were formed on the basis of the same organism and satisfy predetermined quality.

Further, according to the present invention, there is also provided an organism information registering apparatus comprising:

an organism information forming unit which forms organism information on the basis of an organism; and

a target processing unit which executes a target process regarding registration by using the organism information formed by the organism information forming unit,

in which when the target processing unit instructs activation of the organism information forming unit, the organism information forming unit notifies the target processing unit of information for the target process,

wherein the target processing unit has

a processing information obtaining unit which obtains processing information necessary for the target process by the notification from the organism information forming unit;

a processing procedure deciding unit which decides a processing procedure for the target process on the basis of the obtained processing information;

a quality managing unit which discriminates quality of the organism information formed by the organism information forming unit and instructs the organism information forming unit to form the organism information again until organism information which satisfies predetermined quality is formed in accordance with the decided processing procedure; and

a processing unit which executes the target process by using the organism information which satisfies the predetermined quality in accordance with the processing procedure, and

the organism information forming unit has

a processing information holding unit which holds the processing information, and

an organism information re-forming unit which forms new organism information again on the basis of the organism when it receives the re-forming instruction from the processing unit and notifies the target processing unit of the re-formed organism information.

Moreover, in the organism information registering apparatus, at least one of the following information is shown in the information:

organism type information showing a type of the organism;

kind information showing a kind of information included in the organism information;

progress information showing a progress of the processing procedure;

status information showing an operating mode of the organism information forming unit;

application information showing a using method of the organism information in the target process; and

registration number information showing the number of registered items in the organism information of the organism.

Moreover, in the organism information registering apparatus, the processing procedure deciding unit decides the next processing procedure on the basis of at least one of the progress information showing the progress of the processing procedure and the status information showing the operating mode of the organism information forming unit.

Moreover, in the organism information registering apparatus, the target processing unit has a display screen control unit which makes display control of a display screen, and the display screen control unit makes the display control of the display screen in accordance with the processing procedure.

Moreover, in the organism information registering apparatus, the display screen control unit makes the display control of the display screen on the basis of at least one of the progress information showing the progress of the processing procedure and the status information showing the operating mode of the organism information forming unit.

Moreover, in the organism information registering apparatus, the quality managing unit makes a severe quality management by collating a plurality of organism information which were formed on the basis of the same organism and satisfy predetermined quality.

Furthermore, according to the present invention, there is also provided an organism information collating apparatus comprising:

an organism information forming unit which forms organism information on the basis of an organism; and

a target processing unit which executes a target process regarding collation by using the organism information formed by the organism information forming unit,

in which when the target processing unit instructs activation of the organism information forming unit, the organism information forming unit notifies the target processing unit of information for the target process,

wherein the target processing unit has

a processing information obtaining unit which obtains processing information necessary for the target process by the notification from the organism information forming unit;

a processing procedure deciding unit which decides a processing procedure for the target process on the basis of the obtained processing information;

a quality managing unit which discriminates quality of the organism information formed by the organism information forming unit and instructs the organism information forming unit to form the organism information again until organism information which satisfies predetermined quality is formed in accordance with the decided processing procedure; and

a processing unit which executes the target process by using the organism information which satisfies the predetermined quality in accordance with the processing procedure, and

the organism information forming unit has

a processing information holding unit which holds the processing information, and

an organism information re-forming unit which forms new organism information again on the basis of the organism when it receives the re-forming instruction from the processing unit and notifies the target processing unit of the re-formed organism information.

Moreover, in the organism information collating apparatus, at least one of the following information is shown in the information:

organism type information showing a type of the organism;

kind information showing a kind of information included in the organism information;

progress information showing a progress of the processing procedure;

status information showing an operating mode of the organism information forming unit;

application information showing a using method of the organism information in the target process; and

registration number information showing the number of registered items in the organism information of the organism.

Moreover, in the organism information collating apparatus, the processing procedure deciding unit decides the next processing procedure on the basis of at least one of the progress information showing the progress of the processing procedure and the status information showing the operating mode of the organism information forming unit.

Moreover, in the organism information collating apparatus, the target processing unit has a display screen control unit which makes display control of a display screen, and the display screen control unit makes the display control of the display screen in accordance with the processing procedure.

Moreover, in the organism information collating apparatus, the display screen control unit makes the display control of the display screen on the basis of at least one of the progress information showing the progress of the processing procedure and the status information showing the operating mode of the organism information forming unit.

Moreover, in the organism information collating apparatus, the quality managing unit makes a severe quality management by collating a plurality of organism information which were formed on the basis of the same organism and satisfy predetermined quality.

According to the organism information authenticating apparatus of the invention, the target processing unit decides procedures for the target processes on the basis of the processing information obtained from the organism information forming unit and controls the organism information obtaining unit in accordance with the decided processing procedures. Therefore, in the organism information obtaining unit, there is no need to provide a special function for managing the processing procedures in the organism information obtaining unit. The organism information obtaining unit having the generality can be provided. The generality in the organism information authenticating apparatus can be improved.

Further, the target processing unit discriminates the quality of the organism information formed by the organism information forming unit in accordance with the decided processing procedures and instructs the organism information forming unit to form the organism information again until the organism information which satisfies the predetermined quality is formed, so that the organism information of the high quality can be obtained. Thus, the organism information authenticating apparatus of the invention can execute the target processes on the basis of the organism information of the high quality.

The above and other objects and features of the present invention will become apparent from the following detailed description and the appended claims with reference to the accompanying drawings.

### BRIEF DESCRIPTION OF THE DRAWINGS

FIG. 1 is a block diagram of an organism information authenticating apparatus of the invention;

FIG. 2 is a diagram showing a method of deciding processing procedures; and

FIG. 3 is a diagram showing a sequence chart of the organism information authenticating apparatus of the invention.

### DETAILED DESCRIPTION OF THE PREFERRED EMBODIMENT

An embodiment of the invention will now be described in detail hereinbelow with reference to the drawings.

The general organism information authenticating apparatus forms organism information on the basis of the organisms such as fingerprint, voiceprint, face type, vein, iris, or the like of the user and collates the organism information with organism information which has previously been registered, thereby performing the personal authentication. In the embodiment, explanation will be made hereinbelow with respect to an example in which the personal authentication is made by the fingerprint.

### Embodiment 1

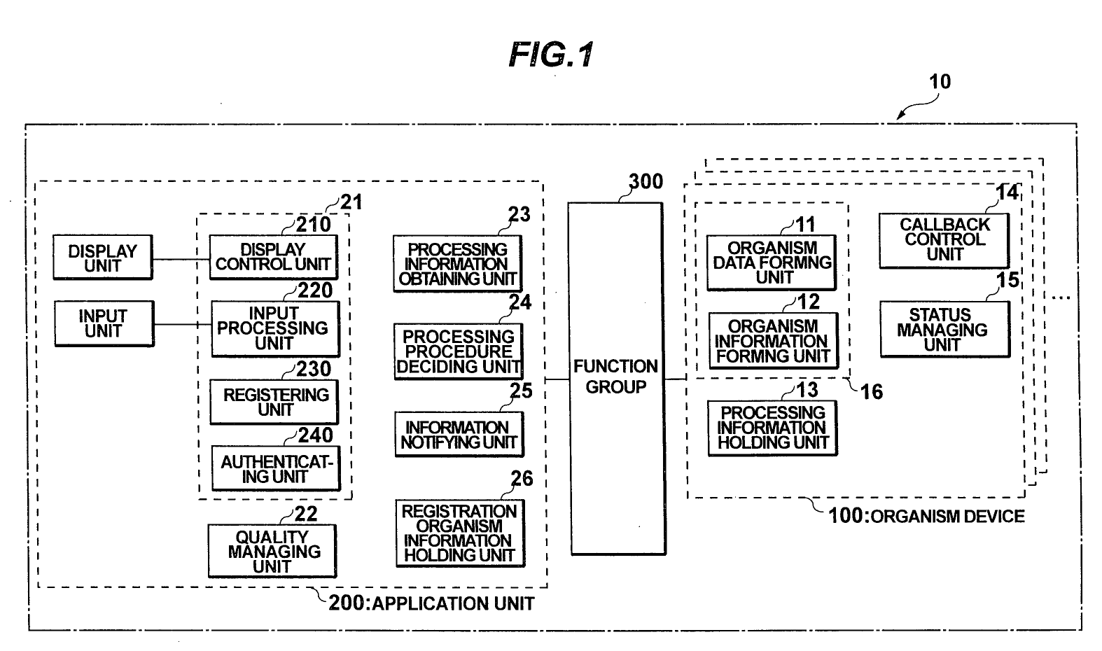

As shown in FIG. 1, an organism information authenticating apparatus 10 of the invention for performing personal authentication by using organism information which is formed on the basis of a fingerprint of the user has: an organism device 100 as an organism information forming unit which forms the organism information; an application unit 200 as a target processing unit which executes target processes regarding the authentication on the basis of the organism information of high quality formed by the organism device 100; and a function designating unit 300 which designates the organism device 100 as a function when the organism device 100 is designated by the application unit 200.

The function designating unit 300 manages a group of various functions as a function group and calls (activating instruction) the function (organism device 100) designated from the function group by the application unit 200.

The organism device 100 which is called as a function from the function designating unit 300 is substantially constructed by hardware such as a camera or the like for obtaining an image of the organism and software for making control of the hardware, a process of the obtained image, and the like. In the embodiment, functions in the organism device 100 are regarded as blocks and will be explained without distinguishing the hardware from the software for convenience of explanation.

The organism device 100 has: an organism data forming unit 11 which digitally photographs an image of a fingerprint as an organism and forms organism data; an organism information forming unit 12 which forms organism information on the basis of the organism data formed by the organism data forming unit 11; a processing information holding unit 13 which holds processing information, which will be explained hereinafter; and a callback control unit 14 for making a callback to the application unit 200.

The organism data forming unit 11 digitally photographs the fingerprint of a finger and forms the organism data. The organism data forming unit 11 can also extract a feature of the fingerprint and form the organism data besides the operation for digitally photographing the fingerprint and forming the organism data.

The organism information forming unit 12 discriminates quality of the organism data formed by the organism data forming unit 11 on the basis of a predetermined reference. If it is determined by this discrimination that the organism data does not satisfy such a reference, the organism information forming unit 12 instructs the organism data forming unit 11 to form the organism data again. The organism information forming unit 12 forms the organism information on the basis of the organism data determined to be the data which satisfies the predetermined reference in the above discrimination.

The organism information which is formed by the organism information forming unit 12 differs depending on the kind of organism. For example, if the organism is the fingerprint, the organism information is the organism data (image data) formed by digitally photographing the fingerprint, or a feature amount is extracted on the basis of the organism data and the digital data of the extracted feature amount or the like is the organism information. If the organism is the iris, a feature amount of the digitally photographed iris is extracted and the digital data of the extracted feature amount or the like is the organism information. If the organism is the voiceprint, the organism information is the organism data formed by digitally recording the voice, or a feature amount is extracted on the basis of the organism data and the digital data of the extracted feature amount or the like is the organism information. Besides each of the above data, text data obtained on the basis of such data or the like can be also included in the organism information.

The organism information forming unit 12 makes a discrimination (hereinafter, referred to as self checks) about the quality such as focusing, white balance, whether or not the object was caught, and the like. If it is decided by the self checks that the organism data does not satisfy the predetermined reference, the organism information forming unit 12 instructs the organism data forming unit 11 to form the organism data again. If the photographing is the contact photographing, there is also a case where the organism data of the high quality cannot be obtained due to an increase/decrease in contact pressure of the finger or the like. Also in such a case, the organism information forming unit 12 instructs the organism data forming unit 11 to form the organism data again.

The self check of the organism data mentioned above has been predetermined on the basis of the quality specifications of the organism device 100 and the repetitive number of times of instruction of the re-forming is normally set to about a few times.

Depending on the quality specifications of the organism device 100, there is a case where a discrimination reference of the self checks about the focusing, white balance, whether or not the object was caught, and the like is lax. In such a case, in spite of the organism data whose quality is substantially low, there is a fear that such organism data is determined to be not the organism data of the low quality. In order to take a countermeasure against such a fear, the quality of the organism information formed on the basis of the organism data of substantially the low quality is checked in the application unit 200, which will be explained hereinafter.

In the quality check of the organism information in the application unit 200, if it is determined that the organism data does not satisfy the predetermined quality reference, the application unit 200 requests the organism device 100 to form the organism information again. The organism device 100 which received such a request forms the organism information again by an organism information re-forming unit 16 constructed by the organism data forming unit 11 and the organism information forming unit 12.

The processing information holding unit 13 holds the following information as processing information: organism type information showing the type of organism such as fingerprint, voiceprint, face type, vein, iris, or the like; kind information which can discriminate the kind of data included in the organism information; progress information showing a progress situation of processing procedures (processing contents), which will be explained hereinafter; application information which can discriminate whether the organism information which is used for the target process in the application unit 200, which will be explained hereinafter, is the information for the registration or the authentication; registration number information showing the number of data included in the organism information, for example, the number of fingers whose fingerprints have been obtained; status information indicative of the operating mode of the organism device 100; and the like.

In each information of the processing information held in the processing information holding unit 13, for example, the information regarding fundamental performance of the organism device 100 such as an organism type or the like has previously been held. On the basis of such information, the application unit 200 decides the processing procedures.

The callback control unit 14 controls the callback to the application unit 200 and notifies the application unit 200 of the organism information formed in the organism device 100. When the callback control is made, the application unit 200 is notified of the operating mode and the processing result in the organism device 100 as a status. The status is formed by a status managing unit 15. When the status managing unit 15 forms the status, it refers to the processing information held in the processing information holding unit 13 as necessary.

The status in the organism device 100 is reflected to the processing information held in the processing information holding unit 13. That is, the processing information is properly updated in accordance with the processing situation or processing contents in the organism device 100.

The application unit 200 has: a processing unit 21 which executes the target processes; a quality managing unit 22 which manages the quality of the organism information; a processing information obtaining unit 23 which obtains the processing information from the organism device 100; a processing procedure deciding unit 24 which decides the processing procedures on the basis of the obtained processing information; an information notifying unit 25 which notifies the organism device 100 of the return information to the organism device 100 for making the callback control; and a registration organism information holding unit 26 which holds the organism information as registration organism information in order to register the organism information obtained from the organism device 100.

The processing unit 21 executes the processes in accordance with the processing procedures decided in the processing procedure deciding unit 24. In order to execute the processes in accordance with the processing contents, the processing unit 21 has: a display control unit 210 which controls the display of a display screen of the display unit; an input processing unit 220 which obtains input contents inputted from the input unit; a registering unit 230 which allows the registration organism information holding unit 26 to hold the organism information obtained from the organism device 100 as organism information for registration; and an authenticating unit 240 which performs the personal authentication by collating the organism information for collation obtained from the organism device 100 with the registration organism information held in the registration organism information holding unit 26.

The display control unit 210 controls the display screen of the display unit in accordance with the processing procedures decided in the processing procedure deciding unit 24. As a display screen whose display is controlled by the display control unit 210, besides a menu display screen, a registration display screen, a collation display screen, and the like, for example, the display screen in the organism device 100 is also display-controlled. That is, the display control unit 210 makes the display control of a guide display screen at the time when the organism of the user is digitally photographed, a display screen of a photographed result, and the like in the organism device 100. In association with the display control, the application unit 200 obtains the status of the organism device 100, the organism information, and the like from the organism device 100. The obtained information is sent to the display control unit 210. When the display control of the display screen is made in accordance with the processing procedures, the display control unit 210 refers to the obtained information.

The input processing unit 220 obtains the input contents inputted from the input unit such as an operation button, keyboard, or the like. The display control unit 210, registering unit 230, authenticating unit 240, quality managing unit 22, and the like are notified of the obtained input contents. Each of the processing units which received the notification executes the process according to the input contents.

When the registering unit 230 obtains the organism information from the organism device 100 in order to register the organism information of the user, the quality managing unit 22 is made to check the quality of the obtained organism information. The registering unit 230 makes control to allow the registration organism information holding unit 26 to hold the organism information determined to be a predetermined quality reference or higher by the quality managing unit 22.

The organism device 100 which received the obtaining request of the organism information makes the callback control to the application unit 200. For the control in the application unit 200, the status of the organism device 100 and the obtained organism information are notified to the application unit 200 from the organism device 100.

The registering unit 230 which received the notification instructs switching control of the display screen to the display control unit 210 in order to display the display screen according to the notification contents and instructs a quality check to the quality managing unit 22 in order to check the quality of the organism information.

The quality managing unit 22 discriminates whether or not the organism information from the organism device 100 satisfies the predetermined quality reference. Until the organism information which satisfies the predetermined quality reference is formed, the quality managing unit 22 instructs the organism device 100 to form the organism information again. Specifically speaking, if it is determined that the organism information does not satisfy the predetermined quality reference, the quality managing unit 22 allows the information notifying unit 25 to form information showing that the organism information does not satisfy the predetermined quality reference and notify the organism device 100 of such information.

In the quality discrimination of the organism information in the quality managing unit 22, generally, its logic is more complicated and the discrimination is severer than those of the self check which is executed in the organism device 100.

For example, depending on the quality specifications of the organism device 100, there is a case where the discrimination reference of the self checks about the focusing, white balance, whether or not the object was caught, and the like is lax. In such a case, the organism information determined to be not the organism data of the low quality because the discrimination reference is lax in spite of the organism data whose quality is substantially low is also severely subjected to the quality discrimination in the quality managing unit 22, so that it is correctly determined to be the organism information of the low quality. In the subsequent processes, the processes can be executed in the quality managing unit 22 on the basis of the organism information which satisfies the quality reference.

The authenticating unit 240 obtains the organism information of an authentication target person from the organism device 100 in order to collate the authentication target person. The quality of the obtained authentication organism information is checked in the quality managing unit 22. The authenticating unit 240 performs the personal authentication by collating the authentication organism information determined to be the predetermined quality reference or higher in the quality managing unit 22 with the registration organism information held in the registration organism information holding unit 26. An authentication result is notified to the display control unit 210. The display control unit 210 makes control to display the authentication result onto the display screen.

The processing information obtaining unit 23 obtains the processing information held in the organism device 100. The processing information is the status sent from the organism device 100 by the callback control from the organism device 100. The processing information obtaining unit 23 makes control to obtain the status as processing information. The obtained processing information is transmitted to the registering unit 230, authenticating unit 240, quality managing unit 22, processing procedure deciding unit 24, and the like in accordance with the processing contents in the application unit 200.

The processing procedure deciding unit 24 which received the processing information from the processing information obtaining unit 23 determines processing procedures of the contents to be processed, their order, and the like on the basis of each information included in the processing information.

The processing procedures which are decided in the processing procedure deciding unit 24 include: a processing procedure when responding to the callback from the organism device 100; a processing procedure for obtaining the organism information; a processing procedure in the target process; and the like. They further include a processing procedure for the display control of the display screen in each of the processing procedures and the like.

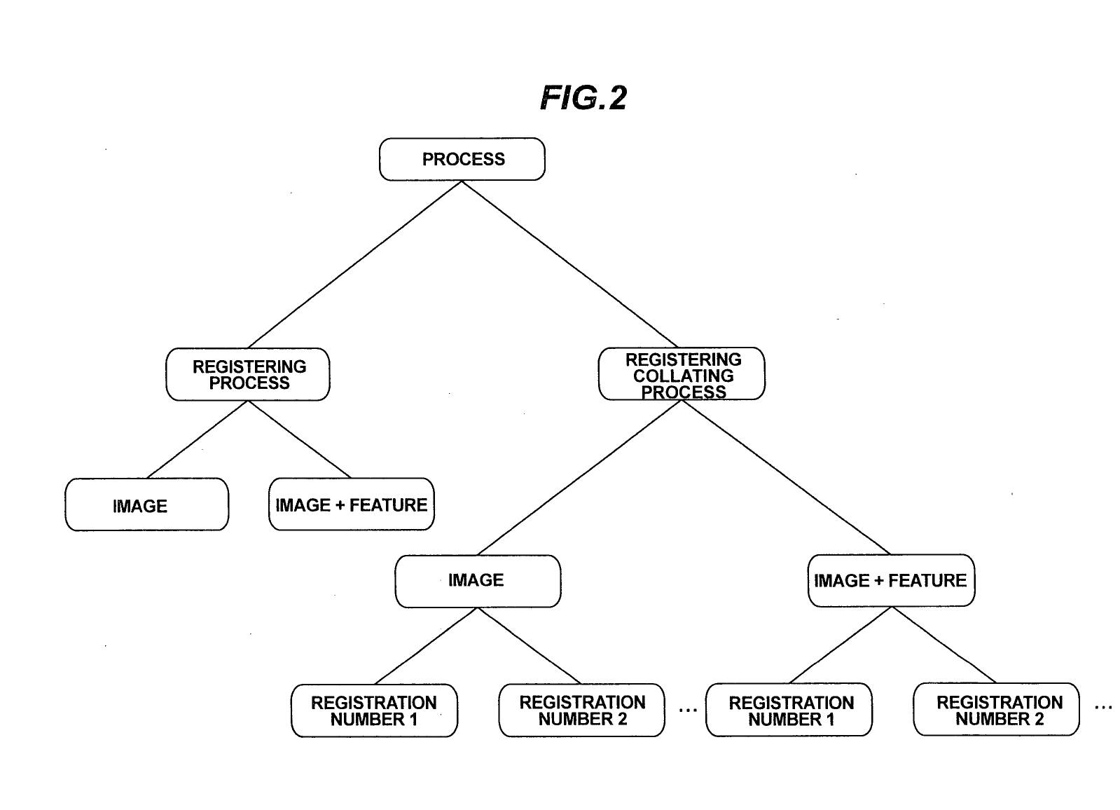

As for the processing procedures, as shown in FIG. 2, the contents to be processed and their order are determined as processing procedures by tracing the processing contents having a tree structure on the basis of the processing information. For example, the type of organism is discriminated on the basis of the organism type information included in the processing information. The control contents such as display control according to the type of organism, obtainment control of the organism information, control in the target process, and the like are determined. The application contents of the organism information is discriminated on the basis of the application information. The control contents such as display control according to the application contents of the organism information, control in the target process, and the like are determined. The data kind of the organism information included in the obtained organism information on the basis of the kind information is discriminated. The control contents such as display control according to the data kind, control in the target process, and the like are determined. The number of samples of the organism at the time of forming the organism information is discriminated on the basis of the obtaining number information. The control contents such as display control according to the sampling number, obtainment control of the organism information, control in the target process, and the like are determined from the predetermined processing contents.

On the basis of the progress information obtained from the organism device 100 and the processing result in the organism device 100, the processing procedure deciding unit 24 can properly decide again the processing procedures which have been determined once. In other words, the processing procedure deciding unit 24 can decide the processing procedures in accordance with the progress state of the process or in accordance with the contents of the processing result in the organism device 100.

It is unnecessary to limit the deciding method of the processing procedures in the processing procedure deciding unit 24 to the foregoing method but the contents of the processes with the tree structure and the constructing order in the tree structure are properly changed in accordance with the specifications in the application unit 200.

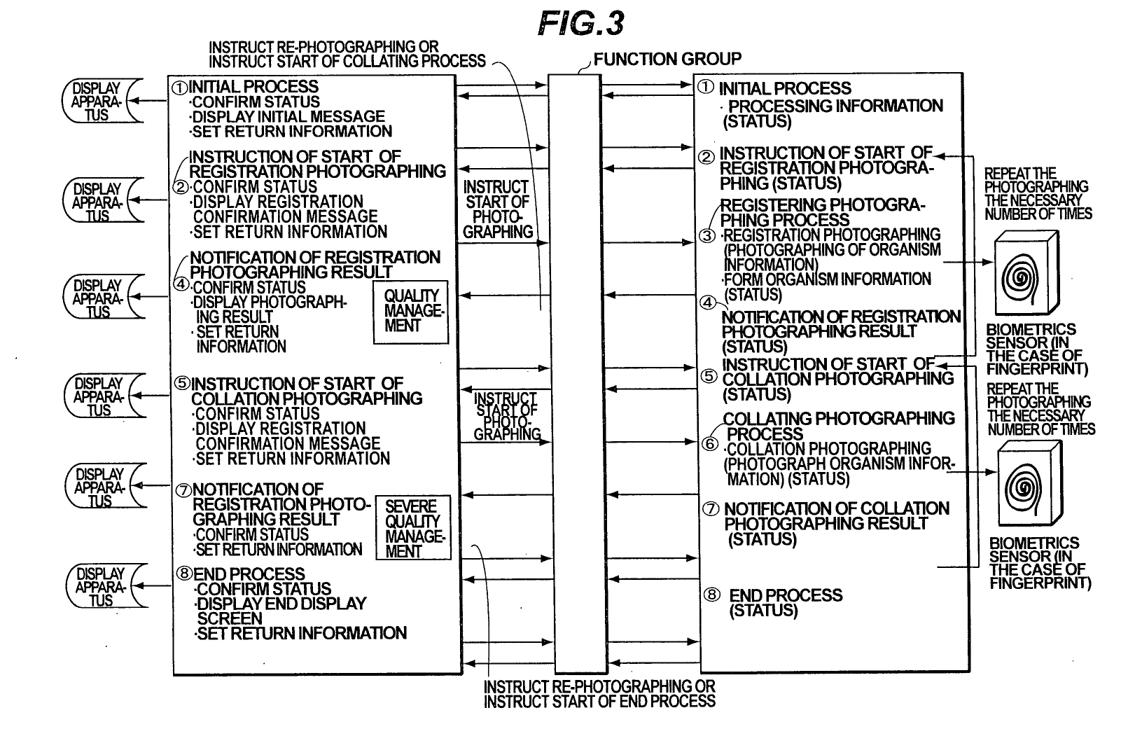

The operation of the organism information authenticating apparatus 10 of the invention will now be described with reference to a sequence chart of FIG. 3.

A menu display screen is displayed in the display unit of the organism information authenticating apparatus 10. The display of the menu display screen is controlled by the display control unit 210 on the basis of the predetermined processing procedures. Items such as registration, collation, and the like of the organism information are displayed in the menu display screen. When the user designates “register” by the input unit by which he can select the display items, the registering unit 230 is notified of the designated item. Moreover, when item “register” is designated, the organism information authenticating apparatus 10 operates as an organism information registering apparatus; and when item “collation” is designated, the organism information authenticating apparatus 10 operates as an organism information collating apparatus.

To obtain the organism information, the registering unit 230 requests the organism device 100 to obtain the processing information for an initial process. At this time, the registering unit 230 activates the processing information obtaining unit 23.

The processing information obtaining unit 23 instructs the function designating unit 300 to call (activate) the organism device 100 managed as a function.

In order to notify the application unit 200 of the processing information necessary for the initial process in the application unit 200, the organism device 100 which received the call allows the callback control unit 14 to notify the application unit 200 of the processing information previously held in the processing information holding unit 13 by the callback control.

To decide the processing procedures on the basis of the processing information, the application unit 200 which obtained the processing information from the organism device 100 by the processing information obtaining unit 23 notifies the processing procedure deciding unit 24 of the obtained processing information.

The processing procedure deciding unit 24 decides the processing procedures of the contents to be processed, their processing order, and the like on the basis of various kinds of information included in the processing information. Specifically speaking, the processing procedure deciding unit 24 decides: the processing procedure when responding to the callback from the organism device 100; the processing procedure in the target (registering) process; the processing procedure to obtain the organism information for registration; and the like. The processing procedure deciding unit 24 further decides the processing procedure for the display control of the display screen in each of the processing procedures and the like.

The registering unit 230 allows the display control unit 210 to make display control of an initial message display screen at the time of registration in accordance with the decided processing procedures. A guide for the user to photograph the organism is shown in the initial message. When an operation guide is displayed on the display screen, information showing a progress situation of the processes so far is formed in the information notifying unit 25 and the formed information is notified to the organism device 100.

The organism device 100 which received the information activates the organism data forming unit 11 so as to photograph the organism of the user and form the organism data. If the organism data forming unit 11 can photograph various portions of the organism in accordance with the function specifications, the status is formed in the status managing unit 15 in order to obtain an instruction about which portion should be photographed from the application unit 200. The application unit 200 is notified of the formed status by the callback control of the callback control unit 14.

When the application unit 200 obtains the notification from the organism device 100 by the processing information obtaining unit 23, the guide display screen is displayed in the display unit by the display control unit 210 so that the registering unit 230 allows the user to select the portion of the organism to be photographed in accordance with the decided processing procedures.

When the photographing portion is selected in accordance with the guide display screen, information showing the selected portion is formed in the information notifying unit 25 and notified to the organism device 100.

The organism device 100 specifies the photographing portion of the organism on the basis of the information from the application unit 200.

A photograph start button (not shown) is provided for the organism data forming unit 11. When the user presses this button, the organism is photographed and the organism data is formed.

The self check of the quality of the formed organism data is performed in the organism information forming unit 12. When the organism data satisfies the predetermined quality reference, the organism information forming unit 12 forms the organism information on the basis of the organism data.

When the organism information is formed, information showing the quality of the organism data and the progress information showing the progress situation of the processes in the organism device 100 are formed in the status managing unit 15. The callback control is made in the callback control unit 14 so as to notify the application unit 200 of those information.

If it is decided in the self check that the organism data does not satisfy the predetermined quality reference, the organism is photographed again to form the organism data again. If the organism data which satisfies the predetermined quality reference cannot be formed even after the re-photographing was executed a predetermined number of times, a status indicative of such a fact is formed in the status managing unit. The callback control is made in the callback control unit 14 so as to notify the application unit 200 of such a status.

The application unit 200 which obtained the organism information from the organism device 100 allows the display control unit 210 to make the display control in order to display the image of the organism shown in the organism information to the display unit in accordance with the processing procedures.

The quality of the organism information is discriminated in the quality managing unit 22 in accordance with the processing procedures. Since the discrimination reference in the quality discrimination in the quality managing unit 22 is generally severer than that of the self check in the organism device 100, only the organism information of the high quality determined in the quality managing unit 22 is registered into the registration organism information holding unit 26 by the registering unit 230.

If it is decided in the quality managing unit 22 that the organism information does not satisfy the predetermined quality reference, information indicating a re-obtaining request is formed in the information notifying unit 25 in order to obtain the organism information again and the organism device 100 is notified of such information.

The organism device 100 which received the re-obtaining request photographs the organism again, forms the organism information again, and notifies the application unit 200 of the organism information.

In this manner, the quality managing unit 22 allows the organism information re-forming unit 16 of the organism device 100 to re-form the organism information until the organism information of the high quality is obtained. Thus, the application unit 200 can obtain the organism information of the high quality.

If the processing procedures have been predetermined so as to severely check again the organism information determined as information which satisfies the predetermined quality reference, the organism information determined as information which satisfies the quality reference in the application unit 200 is collated with the organism information newly formed on the basis of the same organism. If it is determined that a difference between the organism information obtained by the collation is within a predetermined reference, it is determined that the formed organism information severely satisfies the predetermined quality. In the embodiment, such a quality management of the organism information is called severe quality management (severe quality discrimination). The severe quality management will be described in detail.

The severe quality management is effective in the following case. For example, in the case where a finger is contact-photographed, a feature is extracted from the organism data of the obtained fingerprint, and the feature is used as organism information in order to obtain the organism information of the fingerprint of the finger, the organism data of the high quality is formed without causing any problem in the adjustment of focusing, exposure, and the like. However, if the contact pressure is weak due to some cause, a photographing area of the object is narrowed, so that the feature amount which is obtained from the organism data of the object of the narrow photographing area also decreases. If the feature amount is small as mentioned above, when the collation is made later on the basis of the feature amount, the number of collation items decreases, so that there is a fear that the erroneous discrimination result is caused.

To prevent the registration of the organism information which causes the erroneous discrimination as mentioned above, by collating the organism information obtained by contact-photographing the finger at the weak contact pressure with the organism information newly formed on the basis of the same organism, if the contact photographing for the organism information to be newly formed has been performed at the correct contact pressure, the organism information obtained by performing the contact photographing at the correct contact pressure does not coincide with the organism information obtained by performing the contact photographing at the weak contact pressure in the collation result. The organism information obtained by performing the contact photographing at the weak contact pressure can be detected.

The operation of the severe quality management will now be specifically explained.

If the processing procedures have been predetermined so as to make the severe quality management, to make the organism device 100 form the new organism information on the basis of the same organism, the registering unit 230 allows the information notifying unit 25 to form information showing such an instruction and notifies the organism device 100 of such information.

In order to allow the organism device 100 to obtain an instruction about which portion should be photographed in the organism that has already been photographed from the application unit 200 so as to re-form the organism information on the basis of the information, the status to obtain such an instruction is formed by the status managing unit 15. The application unit 200 is notified of the formed status by the callback control of the callback control unit 14.

When the application unit 200 obtains the notification from the organism device 100 by the processing information obtaining unit 23, the registering unit 230 forms information to instruct the photographing of the organism of the same portion as that of the organism which has already been photographed by the information notifying unit 25 in accordance with the decided processing procedures. At this time, the guide display screen to display a message for starting the photographing is displayed on the display unit under the display screen control of the display control unit 210.

When the organism device 100 is notified of the information formed in the information notifying unit 25, the organism device 100 specifies the photographing portion of the organism on the basis of the information and waits for the instruction to start the photographing from the user. When the user presses the photographing start button, the organism is photographed and the organism data is formed in the organism data forming unit 11.

The self check of the quality of the formed organism data is performed by the organism information forming unit 12. When the organism data satisfies the predetermined quality reference, the organism information forming unit 12 forms the organism information on the basis of the organism data. When the organism information is formed, the information showing the quality of the organism data and the progress information showing the progress situation of the processes in the organism device 100 are formed in the status managing unit 15. The callback control is made by the callback control unit 14 to notify the application unit 200 of those information.

In the application unit 200 subjected to the callback control, the quality of the organism information newly formed on the basis of the same organism is discriminated by the quality managing unit 22. The organism information determined to be the predetermined quality reference or higher and the organism information which has already been obtained are collated by the quality managing unit 22. If it is determined that a difference between those organism information is within the predetermined reference, the registering unit 230 registers the organism information into the registration organism information holding unit 26.

As mentioned above, by collating the two organism information formed on the basis of the same organism by the quality managing unit 22, the quality of the organism information can be more severely managed.

The discrimination result in the quality managing unit 22 is displayed on the display unit under the display control of the display control unit 210. Information indicative of the discrimination result in the quality managing unit 22 is formed by the information notifying unit 25 and the organism device 100 is notified of such information.

In the organism device 100 which received the information, organism information is newly formed by the organism information re-forming unit 16 when the information indicates the dissidence in the discrimination in the quality managing unit 22.

When the organism device 100 obtains information indicative of the end of creation of the organism information from the application unit 200, the operation in the organism device 100 is stopped. A status indicative of such an operation stop is formed by the status managing unit 15. The application unit 200 is notified of such a status.

When the user designates “authentication” in the selection item on the menu display screen, the processes which are executed until the organism information is formed on the basis of the organism data obtained by photographing the organism of the authentication target person and its quality is managed are substantially the same as those of “registration” mentioned above. Therefore, their explanation is omitted here. When the application unit 200 obtains the organism information for collation, the organism information obtained for the authentication and the registration organism information registered in the registration organism information holding unit 26 are collated and the authentication target person is authenticated in the authenticating unit 240 by the conventional well-known method.

As mentioned above, according to the organism information authenticating apparatus 10 of the invention, the processing procedures are decided by the processing procedure deciding unit 24 on the basis of the processing information from the organism device 100, the organism device 100 is controlled in accordance with the decided processing procedures, and the processing control in the processing unit 21 and control of the display screen are made. Therefore, there is no need to allow the organism device 100 to make the display screen control, the processing control, and the like and the simple organism information obtaining unit in which those functions are omitted can be provided. The generality in the organism information authenticating apparatus can be improved. The display screen is integratedly controlled by the application unit 200. Therefore, the display screen construction, color arrangement, font, and the like can be unified. Further, according to the organism information authenticating apparatus 10 of the invention, since the application unit 200 newly makes the quality management of the organism information which was self-checked by the organism device 100, the quality management of the organism information can be made on the basis of the quality specifications in the application unit 200 without being influenced by the quality specifications of the organism device 100. The organism information of the high quality which is not influenced by the quality specifications of the organism device 100 can be obtained.

According to the foregoing embodiment, the authentication based on the organism information formed on the basis of the organism such as fingerprint, voiceprint, face type, vein, iris, or the like has been described as a typical example. Information formed on the basis of, for example, a speed, a stroke, a pressure put on the writing, or the like in a signature is also information which can discriminate the organism. Such unique information regarding the organism can be also used as organism information.

The present invention is not limited to the foregoing embodiment but many modifications and variations are possible within the spirit and scope of the appended claims of the invention.

What is claimed is:

1. An organism information authenticating apparatus comprising:
an organism information forming unit which forms organism information on the basis of an organism; and
a target processing unit which executes a target process regarding authentication by using the organism information formed by said organism information forming unit,
in which when said target processing unit instructs activation of said organism information forming unit, said organism information forming unit notifies said target processing unit of information for the target process,
wherein said target processing unit has
a processing information obtaining unit which obtains processing information necessary for said target process by the notification from said organism information forming unit;
a processing procedure deciding unit which decides a processing procedure for said target process on the basis of the obtained processing information;
a quality managing unit which discriminates quality of the organism information formed by said organism information forming unit and instructs said organism information forming unit to form the organism information again until organism information which satisfies predetermined quality is formed in accordance with the decided processing procedure; and
a processing unit which executes the target process by using the organism information which satisfies the predetermined quality in accordance with said processing procedure, and
said organism information forming unit has
a processing information holding unit which holds said processing information, and
an organism information re-forming unit which forms new organism information again on the basis of said organism when it receives the re-forming instruction from said processing unit and notifies said target processing unit of the re-formed organism information.

2. The organism information authenticating apparatus according to claim 1, wherein at least one of the following information is shown in said information:
organism type information showing a type of said organism;
kind information showing a kind of information included in said organism information;
progress information showing a progress of said processing procedure;
status information showing an operating mode of said organism information forming unit;
application information showing a using method of the organism information in said target process; and
registration number information showing the number of registered items in the organism information of said organism.

3. The organism information authenticating apparatus according to claim 1, wherein said processing procedure deciding unit decides the next processing procedure on the basis of at least one of the progress information showing the progress of said processing procedure and the status information showing the operating mode of said organism information forming unit.

4. The organism information authenticating apparatus according to claim 1, wherein
said target processing unit has a display screen control unit which makes display control of a display screen, and
said display screen control unit makes the display control of the display screen in accordance with said processing procedure.

5. The organism information authenticating apparatus according to claim 4, wherein said display screen control unit makes the display control of the display screen on the basis of at least one of the progress information showing the progress of said processing procedure and the status information showing the operating mode of said organism information forming unit.

6. The organism information authenticating apparatus according to claim 1, wherein said quality managing unit makes a severe quality management by collating a plurality of organism information which were formed on the basis of the same organism and satisfy predetermined quality.

7. An organism information registering apparatus comprising:
an organism information forming unit which forms organism information on the basis of an organism; and
a target processing unit which executes a target process regarding registration by using the organism information formed by said organism information forming unit,
in which when said target processing unit instructs activation of said organism information forming unit, said organism information forming unit notifies said target processing unit of information for the target process,
wherein said target processing unit has
a processing information obtaining unit which obtains processing information necessary for said target process by the notification from said organism information forming unit;
a processing procedure deciding unit which decides a processing procedure for said target process on the basis of the obtained processing information;
a quality managing unit which discriminates quality of the organism information formed by said organism information forming unit and instructs said organism information forming unit to form the organism information again until organism information which satisfies predetermined quality is formed in accordance with the decided processing procedure; and
a processing unit which executes the target process by using the organism information which satisfies the predetermined quality in accordance with said processing procedure, and
said organism information forming unit has
a processing information holding unit which holds said processing information, and
an organism information re-forming unit which forms new organism information again on the basis of said organism when it receives the re-forming instruction from said processing unit and notifies said target processing unit of the re-formed organism information.

8. The organism information registering apparatus according to claim 7, wherein at least one of the following information is shown in said information:
organism type information showing a type of said organism;
kind information showing a kind of information included in said organism information;
progress information showing a progress of said processing procedure;
status information showing an operating mode of said organism information forming unit;
application information showing a using method of the organism information in said target process; and
registration number information showing the number of registered items in the organism information of said organism.

9. The organism information registering apparatus according to claim 7, wherein said processing procedure deciding unit decides the next processing procedure on the basis of at least one of the progress information showing the progress of said processing procedure and the status information showing the operating mode of said organism information forming unit.

10. The organism information registering apparatus according to claim 7, wherein
said target processing unit has a display screen control unit which makes display control of a display screen, and
said display screen control unit makes the display control of the display screen in accordance with said processing procedure.

11. The organism information registering apparatus according to claim 10, wherein said display screen control unit makes the display control of the display screen on the basis of at least one of the progress information showing the progress of said processing procedure and the status information showing the operating mode of said organism information forming unit.

12. The organism information registering apparatus according to claim 7, wherein said quality managing unit makes a severe quality management by collating a plurality of organism information which were formed on the basis of the same organism and satisfy predetermined quality.

13. An organism information collating apparatus comprising:
an organism information forming unit which forms organism information on the basis of an organism; and
a target processing unit which executes a target process regarding collation by using the organism information formed by said organism information forming unit,
in which when said target processing unit instructs activation of said organism information forming unit, said organism information forming unit notifies said target processing unit of information for the target process,
wherein said target processing unit has
a processing information obtaining unit which obtains processing information necessary for said target process by the notification from said organism information forming unit;
a processing procedure deciding unit which decides a processing procedure for said target process on the basis of the obtained processing information;
a quality managing unit which discriminates quality of the organism information formed by said organism information forming unit and instructs said organism information forming unit to form the organism information again until organism information which satisfies predetermined quality is formed in accordance with the decided processing procedure; and
a processing unit which executes the target process by using the organism information which satisfies the predetermined quality in accordance with said processing procedure, and
said organism information forming unit has
a processing information holding unit which holds said processing information, and
an organism information re-forming unit which forms new organism information again on the basis of said organism when it receives the re-forming instruction from said processing unit and notifies said target processing unit of the re-formed organism information.

14. The organism information collating apparatus according to claim 13, wherein at least one of the following information is shown in said information:
organism type information showing a type of said organism;
kind information showing a kind of information included in said organism information;
progress information showing a progress of said processing procedure;
status information showing an operating mode of said organism information forming unit;
application information showing a using method of the organism information in said target process; and
registration number information showing the number of registered items in the organism information of said organism.

15. The organism information collating apparatus according to claim 13, wherein said processing procedure deciding unit decides the next processing procedure on the basis of at least one of the progress information showing the progress of said processing procedure and the status information showing the operating mode of said organism information forming unit.

16. The organism information collating apparatus according to claim 13, wherein
said target processing unit has a display screen control unit which makes display control of a display screen, and
said display screen control unit makes the display control of the display screen in accordance with said processing procedure.

17. The organism information collating apparatus according to claim 16, wherein said display screen control unit makes the display control of the display screen on the basis of at least one of the progress information showing the progress of said processing procedure and the status information showing the operating mode of said organism information forming unit.

18. The organism information collating apparatus according to claim 13, wherein said quality managing unit makes a severe quality management by collating a plurality of organism information which were formed on the basis of the same organism and satisfy predetermined quality.
